(19) United States
(12) Patent Application Publication
(10) Pub. No.: US 2026/0256639 A1
(43) Pub. Date: Sep. 3, 2026

(54) MODULAR SUPPORT POLE, KITS THEREFOR, AND METHODS RELATED THERETO

(71) Applicant: HealthCraft Products Inc., Ottawa (CA)

(72) Inventors: John Leonard O'Brien, Ottawa (CA); Sunil Biddanda Achia, Ottawa (CA); Thomas Oliver Moore, Ottawa (CA)

(21) Appl. No.: 19/066,866

(22) Filed: Feb. 28, 2025

(51) Int. Cl. A61H 3/00

(52) U.S. Cl. CPC A61H 3/00; A61H 2003/004; A61H 2201/0157; A61H 2201/0161; A61H 2201/0192; A61H 2201/1638

(57) ABSTRACT

Described are various embodiments of a modular support pole, kits therefore and methods related thereto. In one embodiment, the support pole comprises a floor plate; a ceiling plate; and a extensible pole. The extensible pole is made of an upper tubular member coupled at an end thereof to the ceiling plate comprising a plurality of adjustment holes for adjusting the height of the support pole; a middle tubular member, and a lower tubular member. The lower tubular member comprises a plurality of mounting holes for removably affixing thereto an accessory; and a male tensioning threaded member at a lower end thereof coupled to the floor plate. In some embodiments, a pivot bar accessory can be mounted to the pole, lifted, pivoted and lowered to a locking position. Some embodiments comprise an elastomeric textured ceiling pad comprising a raised portion that provides improved compression maintenance.

### FIELD OF THE DISCLOSURE

The present disclosure relates generally to mobility assistance devices, and, in particular, to a modular support pole, kits therefor, and methods related thereto.

### BACKGROUND

Mobility assistance devices such as support poles are essential for ensuring safety and accessibility in various environments. They provide stability and balance, especially for individuals with mobility challenges such as the elderly, and those recovering from injuries. Support pole can be strategically placed in areas where additional assistance is needed.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concepts described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

In accordance with a first aspect, there is provided a support pole comprising: a floor plate; a ceiling plate; and an extensible pole comprising: an upper tubular member coupled at an end thereof to the ceiling plate comprising a plurality of adjustment holes for adjusting the height of the support pole; a middle tubular member, and a lower tubular member comprising: a plurality of mounting holes for removably affixing thereto an accessory; and a male tensioning threaded member at a lower end thereof coupled to the floor plate.

In some embodiments, the plurality of mounting holes are covered by affixing to the lower tubular member a toroidal-shaped member.

In some embodiments, the support pole further comprises a castellated collar slidingly engageable on said lower tubular section, and mounted via said mounting holes, the castellated collar comprising a plurality of upwardly extending teeth; and the accessory is a pivot bar accessory comprising: a handle section; and a tubular support element slidingly engageable on the lower tubular section over said castellated collar, the tubular support element coupled the handle section, and comprising at a lower end thereof a first plurality of downwardly extending teeth configured to fittingly engage in grooves defined between said upwardly extending teeth of the castellated collar, thereby preventing lateral motion of the pivot bar accessory.

In some embodiments, the handle section is C-shaped.

In some embodiments, her groove defines a distinct radial orientation of the handle section.

In some embodiments, the downwardly extending teeth comprise substantially rounded corners.

In some embodiments, the support pole further comprises a tubular sleeve member; and the castellated collar comprises a lip portion configured to support said sleeve member to cover said teeth.

In some embodiments, the accessory is a tray accessory.

In some embodiments, the ceiling plate comprises: one or more resilient pads, each resilient pad comprising a textured surface.

In some embodiments, the textured surface comprises a plurality of grooves.

In some embodiments, each resilient pad further comprises a raised portion configured to store elastic energy upon being compressed against a ceiling surface.

In accordance with another aspect, there is provided a support pole kit comprising: a floor plate; a ceiling plate; an upper tubular member comprising a plurality of adjustment holes for adjusting the height of the support pole; a middle tubular member; and a lower tubular member comprising: a plurality of mounting holes for removably affixing thereto an accessory; and a male tensioning threaded member at a lower end thereof coupled to the floor plate.

In accordance with another aspect, there is provided a method of assembling a support pole, the method comprising: providing a floor plate on a floor; coupling a lower tubular member comprising at a lower end thereof a tensioning member to the floor plate; coupling a lower end of a middle tubular member to the upper end of the lower tubular member; coupling an upper end of an upper tubular member to a ceiling plate; slidingly adjusting an exposed length of the upper tubular member by slidingly moving the upper tubular member through the upper end of the middle tubular member; coupling the upper tubular member to the upper end of the middle tubular member; and tightening the tensioning member until enough tension is exerted by the floor plate and ceiling plate to secure the support pole.

In some embodiments, coupling the lower tubular member with the lower end of the middle tubular member comprises: affixing a castellated collar to a plurality of mounting holes on said lower tubular member; slidingly engaging a sleeve member on the upper end of the lower tubular member until the sleeve member rests on a lip defined on the castellated collar; and downwardly slidingly engaging a tubular support member of a pivot bar accessory onto said upper end of the upper tubular member until downwardly extending teeth of the pivot bar accessory engage grooves defined between upwardly oriented teeth of the castellated collar.

In some embodiments, the method further comprises the steps of: pulling upwards on the pivot bar accessory to disengage the downwardly extending teeth; rotating the pivot bar around the lower tubular member to a designated radial orientation of a handle portion extending therefrom, the designated radial orientation allowing downward engagement of the downwardly extending teeth with said grooves, and downwardly engaging the downwardly extending teeth with said grooves in said designated orientation, thereby preventing lateral motion of the handle portion.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1A is a perspective view of a support pole, in accordance with a first embodiment;

FIG. 1B is a deconstructed view of the support pole shown in FIG. 1A;

FIG. 2A is a perspective view of a support pole with pivot bar, in accordance with a second embodiment;

FIG. 2B is a deconstructed view of the support pole shown in FIG. 2A;

FIG. 3 is a partial cross-sectional view of the support pole with a pivot bar shown in FIG. 2A;

FIGS. 4A through 4F illustrate various steps for pivoting the (pivot bar) shown in FIG. 2A;

FIGS. 5A-5C are various top views of the pivot bar of FIGS. 2A-2B illustrating different exemplary configurations, in accordance with one embodiment;

FIG. 6A and FIG. 6B are perspective views of a support pole with a tray accessory, in accordance with a third embodiment;

FIGS. 7A-7F illustrate various steps for extending the support pole of FIGS. 2A-2B, in accordance with one embodiment;

FIGS. 8A-8C illustrate how the exposed length of the upper tubular member can be adjusted, in accordance with one embodiment;

FIGS. 9A-9D illustrate various aspects of the ceiling pads, in accordance with one embodiment;

FIGS. 10A-10E are various cross-sectional side views illustrating the ceiling plate engaging the ceiling, in accordance with one embodiment;

FIG. 11A and FIG. 11B are a side view and bottom view, respectively, of the floor plate of the support pole, in accordance with one embodiment; and

FIG. 12 and FIG. 13 are disassembled perspective views of a packaged support pole kit and a pivot bar kit, respectively, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The present disclosure provides examples of, in accordance with different embodiments, of a modular support pole, kits therefor, and methods related thereto. The support pole, as will be made clear by the different embodiments discussed below, advantageously provides an improved castellated coupling mechanism that allows to easily pivot and lock various accessories or extensions, including a pivot bar or handle. Other improvements include a ceiling plate comprising leaf textured spring pads for storing energy for compression maintenance, and a bottom positioned jackscrew tension mechanism.

Fully assembled, the support pole can accommodate a floor to ceiling range of 7-10 feet, and is intended for moderate vertical load bearing to provide sitting and standing support for people with reduced mobility. It is not intended to support full body weight. It must be installed between a structural floor and ceiling by turning a jackscrew mechanism at the bottom of the pole. It comprises in some embodiments a high quality, commercial grade pivoting and locking horizontal bar that connects to the support pole. The horizontal bar can be lifted, pivoted and lowered to the next locking position around the support pole.

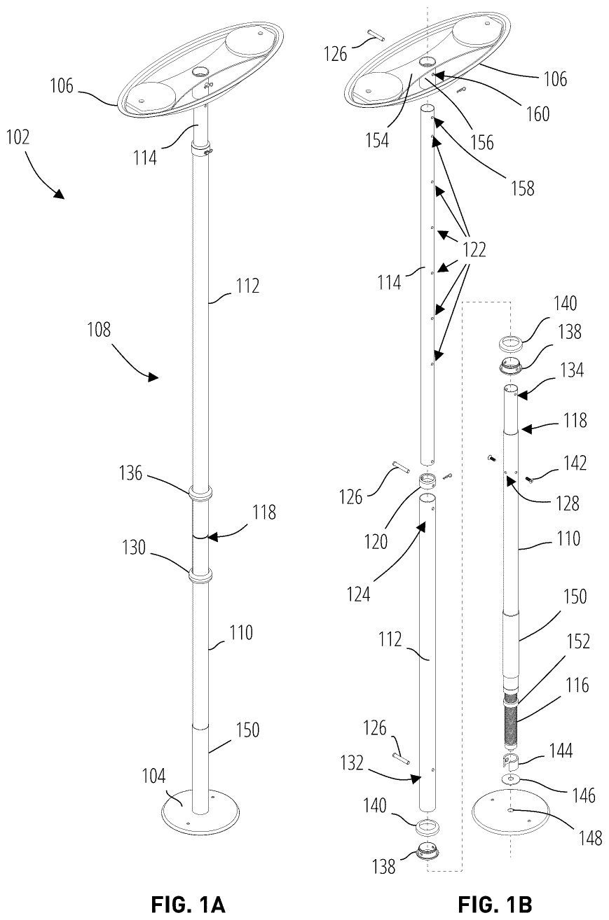

FIG. 1A illustrates an assembled view of a support pole 102, in accordance with one embodiment. FIG. 1B illustrates an unassembled view of the same pole, and provides a clear view of the various components and materials thereof, as will be discussed below. The support pole 102 comprises a floor plate 104 configured to lay on the floor, and a ceiling plate 106 for gently but solidly frictionally engaging the ceiling when the pole is deployed or extended therebetween. The support pole 102 further comprises a linear extendable pole portion 108 comprised of a lower tubular member 110, a middle tubular member 112, and an upper tubular member 114. In this example, each tubular member is substantially cylindrical in shape, although other shapes may be considered. During assembly, the lower tubular member 110, which comprises at the lower end thereof an expansion screw or male threated portion 116, is affixed to the floor plate 104 as will be discussed further below. The middle tubular member 112 can be slidingly engaged over an upper portion of the lower tubular member 110 with a reduced radius, and is supported by a radially extending edge or lip 118 defined thereon. The upper tubular member 114 has a smaller radius than the middle tubular member 112 for slidingly engaging therewith via a collar member 120. The upper member 114 comprises a plurality of adjustment holes 122 used to adjust the desired height of the support pole 102. The upper tubular member 114 is secured by aligning the selected adjustment hole 122 with the securing hole 124 at the top of the middle tubular member 112 via a fastener 126.

The lower tubular member 110 comprises four radially located holes 128. These holes are used for attaching one or more accessories to the support pole, such as the pivot bar discussed further below. However, when no accessory is used, the mounting holes 128 can be covered using a toroidally shaped (i.e., donut shaped) members 130. An upper toroidal member 130 is similarly provided to cover the co-aligned mounting holes 132 and 134 of the middle tubular member 112 and lower tubular member 110 respectively. Each toroidal-shaped member 130 and 136 is composed of a lower member 138 affixed via a corresponding mounting hole therein that co-aligns with a corresponding mounting hole on the pole member, and further comprises an outer lip at the bottom thereof on which rests an upper member 140. In addition to covering the accessory coupling mechanism when not in use, the toroidal members 130 and 136 further provide enhanced gripping near the middle of the support pole 102. As illustrated, most fasteners used to secure the tubular members and the toroidal members use a combination of Clevis pins 126 and hairpins, or threaded fastener 142. It will be appreciated that other types of fasteners may be considered as well, without exception.

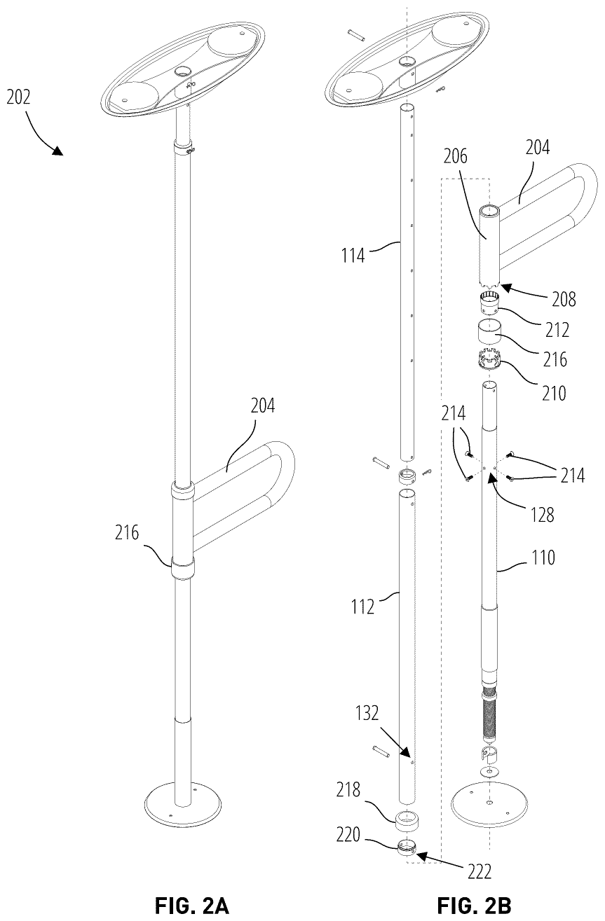

FIG. 2A and FIG. 2B show an assembled and disassembled support pole 202, respectively, in accordance with a second embodiment. In this example, a pivot bar 204 accessory is mounted on the support pole. The pivot bar 204 can be easily pivoted and secured in a variety of orientations, as will be explained below. In the illustrated embodiment, the handle portion of the pivot bar 204 is C-shaped and coupled to a vertical tubular support member 206 having a castellated bottom portion 208 configured to be engageable with a castellated collar 210 through a tapered collar member 212. It will be appreciated that other embodiments (not shown) may have the handle portion differently shaped, for example in the shape of an elongated member extending radially from the pole. This can include straight or curved members, without limitation.

The castellated collar 210 is affixed to the pole via the four threaded holes 128 using fasteners 214 and supports the weight of the pivot bar 204. A plastic sleeve 216 prevents users from accessing the castellated locking mechanism and injuring themselves, including for example by having a finger caught in the space created between the teeth of the castellated collar 210 and the lower portion 208 of the pivot bar during operation.

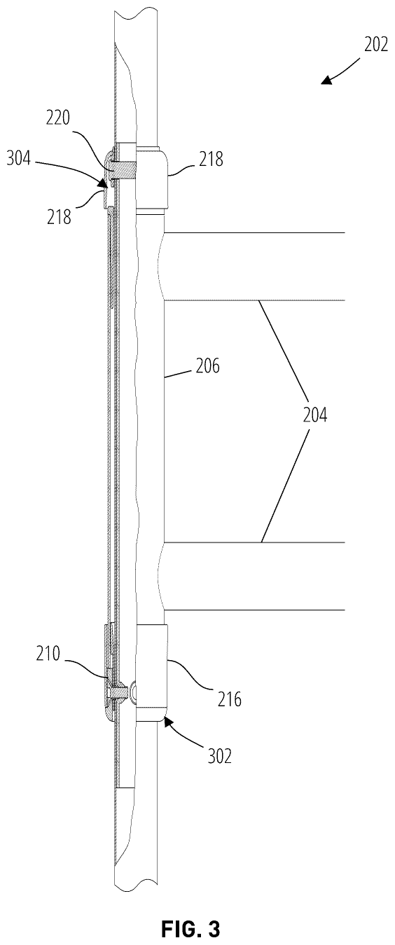

FIG. 3 is a partial cross-sectional view of the support pole 202, and shows the plastic sleeve 216 covering the castellated collar 210 by resting on a lower radially extending lip 302 thereof. Also shown in FIG. 3 is the top cover member 218 resting on a top mounting member 220. The top mounting member 220 comprises a mounting hole 222 that co-aligns when installed with the mounting hole 132 of the middle tubular member 112 is is fastened with fastener 126. Importantly, the top member 218 defines an empty space 304 that allows upward vertical movement of the vertical support member 206, which is required for unlocking and pivoting the bar, as will be described below.

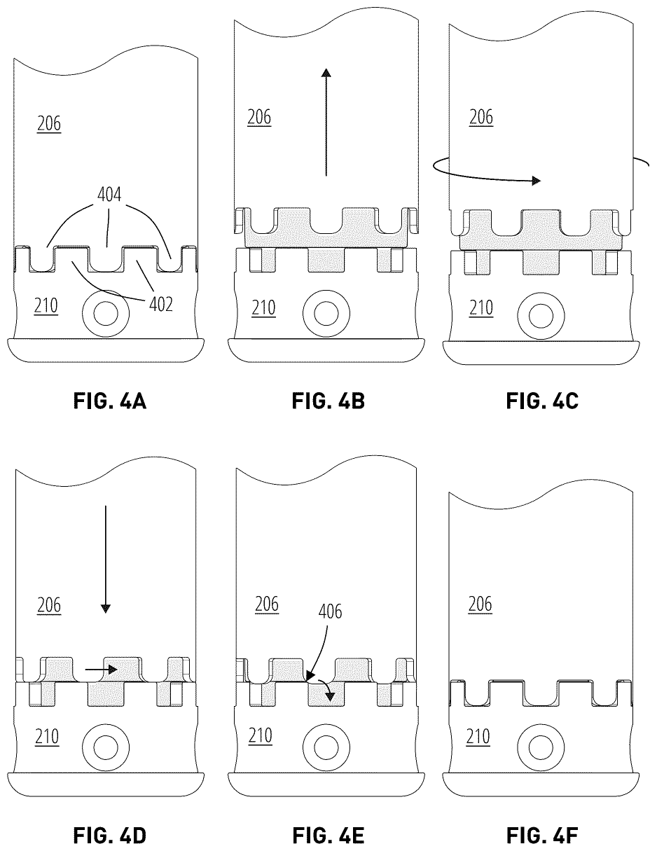

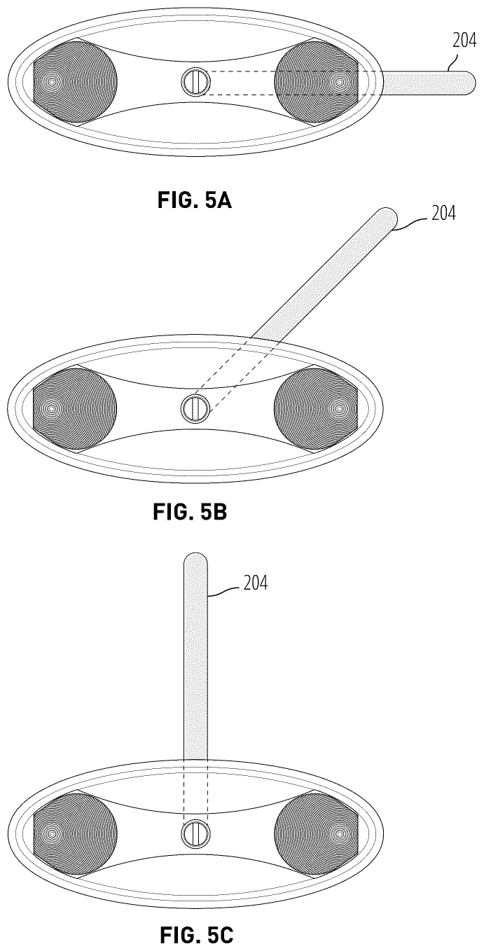

FIGS. 4A-4F illustrate the mechanism by which the castellated collar 210 can be operated to rotate and lock the pivot bar 204 in the desired orientation. In the illustrated embodiment, the castellated collar 210 comprises a plurality of upwardly oriented protrusions or teeth 402. The lower end of the vertical portion 206 of the pivot bar 204 similarly comprises a corresponding plurality of downwardly oriented teeth 404 sized to fittingly engage the grooves defined between the teeth 402 of the castellated collar 210. In this non-limiting example, 8 grooves define 8 corresponding lowered positions (every 45 degrees), although a different number may be considered as well. To pivot the pivot bar 204, the user pulls upward on the pivot bar 204 (FIG. 4B) which lifts the pivot bar 204 upwards and disengages the teeth. The pivot bar 204 can then be rotated or pivoted (FIG. 4C), and once the desired orientation has been reached, the user simply lets the pivot bar 204 fall down (FIG. 4D). Advantageously, the teeth 406 of the pivot bar 204 have rounded corners 406 that allow the teeth 404 of the pivot bar 204 to fall or slip into engagement even when the alignment between the grooves and the teeth is not perfect, as shown in FIG. 4E. Once the teeth are engaged, the pivot bar 204 is locked again (FIG. 4F), thereby preventing any lateral movement thereof. The described locking mechanism avoids having to rely on a pin or similar locking member, which would need to be manipulated by the user which is cumbersome and slow. Only an upward and radially oriented motion is necessary. Moreover, this design further allows for the vertical tubular portion 206 of the pivot bar 204 to have a smaller diameter than older designs, which makes it easier for users to grab onto. In the illustrated embodiment, the pivot bar 204 can be locked in eight different orientations, equally distributed around the support pole, some examples of which are shown in FIGS. 5A-5C.

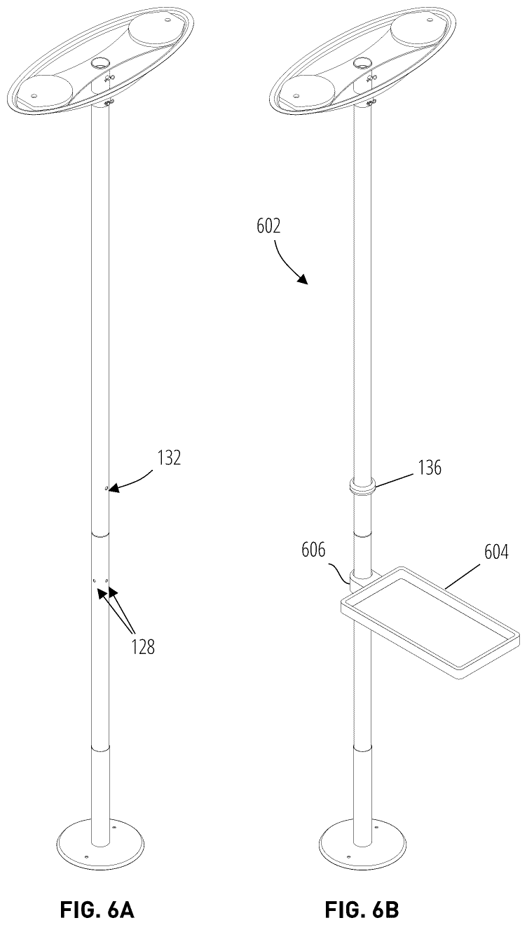

The castellated collar 210 mechanism discussed above may be used with other types of accessories as well, in addition to the pivot bar 204. As a non-limiting example, FIG. 6A and FIG. 6B show another embodiment of a support pole 602 wherein a tray accessory 604 is mounted. This embodiment has the tray accessory 604 comprising a mounting tubular member 606 affixed to the mounting holes 128 of lower tubular member 110. The mounting hole 132 of the middle tubular member 112 can be covered using the toroidal (donut) member 136 as in the embodiment shown in FIG. 1A. It will be appreciated that other types of accessories may be coupled using the mechanism disclosed herein. Non-limiting examples include a tightness gauge, a lighting device, a level, or a linear handrail member.

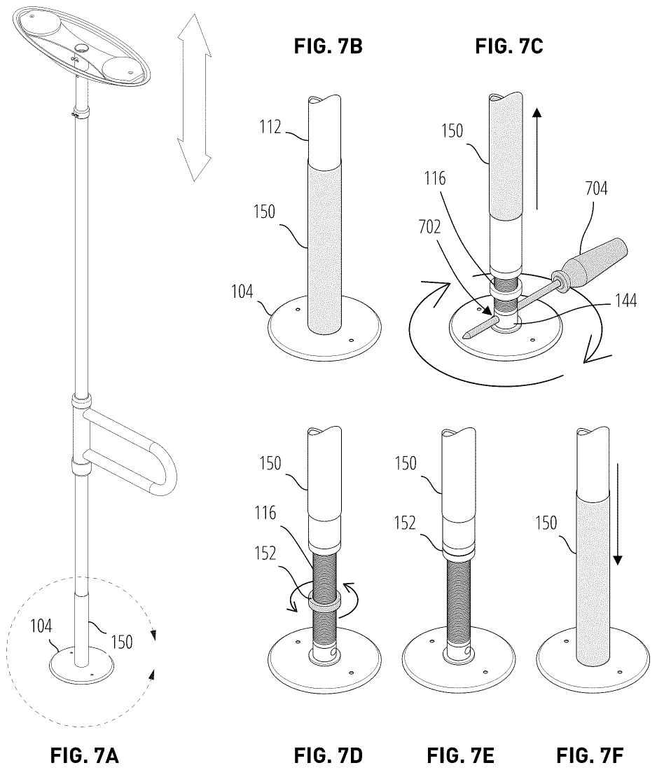

FIG. 7A-7F illustrates the screw jack mechanism used to compress support pole 102/202 between the floor and ceiling of a room, in accordance with one embodiment. The jackscrew mechanism comprises a male threaded member 116 on the lower portion of the lower tubular member 110. The threaded member 116 is affixed to a collar member 144 and washer member 146 at the bottom for engaging downwardly a thru hole 148 in the floor plate 104 (as seen in FIG. 1B). As shown in FIG. 7C, the sleeve member 150 can be slidingly moved upwards to provide access to hole 702 located in the collar member 144. Collar member 144 engages with the bottom of the threaded member 116 (while covering the floorplate thru hole 148) and allows an elongated tool (for example the illustrated screwdriver 704 or similar) to be inserted therethrough to rotate the male threaded member 116 around an axis thereby to expand the support pole and compress it between the ceiling and the floor. The pressure created by the jackscrew mechanism is strong enough for the support pole 102/202 to support the user, yet it does not require drilling holes into the floor or ceiling. This is ideal for relocating or removing the pole. In the preferred embodiment, the male threaded member 116 is a M30X2.000 thread, although a different configuration may be considered as well. Once adjusted, a female threaded collar member 152 can be adjusted to secure the mechanism before being covered by letting the sleeve member 150 slide down. Unlike other designs, the embodiments of the present disclosure have the male threaded member 116 located at the bottom of the pole. This provides that the male threaded member pushes against the floor, and removes the need to have the slidable sleeve covering the member 116 in a location where a user may need to grab onto. Having a slidable sleeve (such as sleeve member 150) located in the middle of the support pole can create an unstable support point for the user (easily twisting or moving), and this is avoided by the disclosed design.

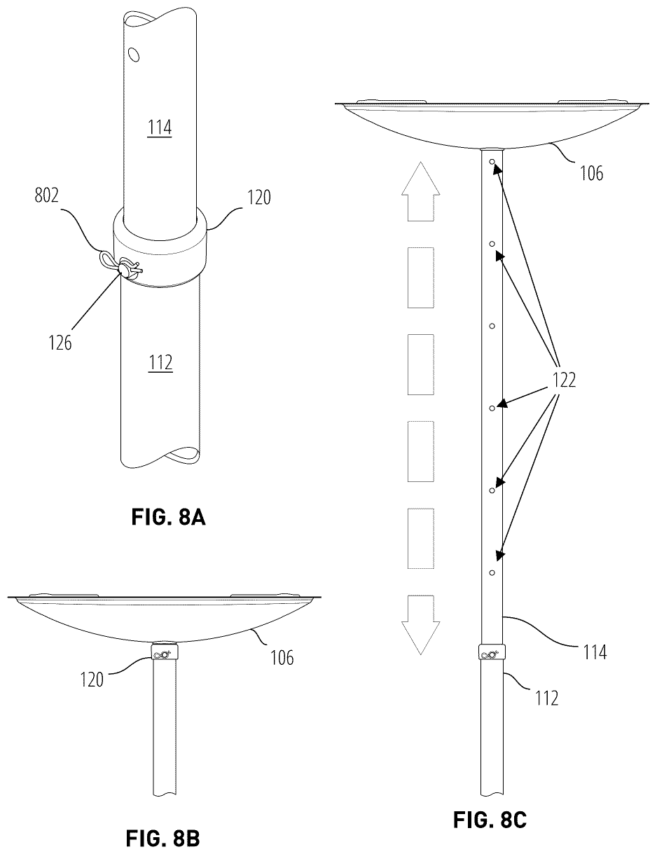

FIG. 8A, FIG. 8B and FIG. 8C illustrate how the height or extension of the upper tubular member 114 can be changed by slidingly moving the member upwards or downwards within middle tubular member 112, and affixing it through the desired adjustment hole 122, the co-aligned hole 124 and the hole in collar member 120. In this example, the members are secured with a Clevis pin 126 and hairpin Cotter pin 802, but as mentioned above, other types of fasteners may be used as well. It will further be appreciated that a different number of adjustment holes than those illustrated may be used as well.

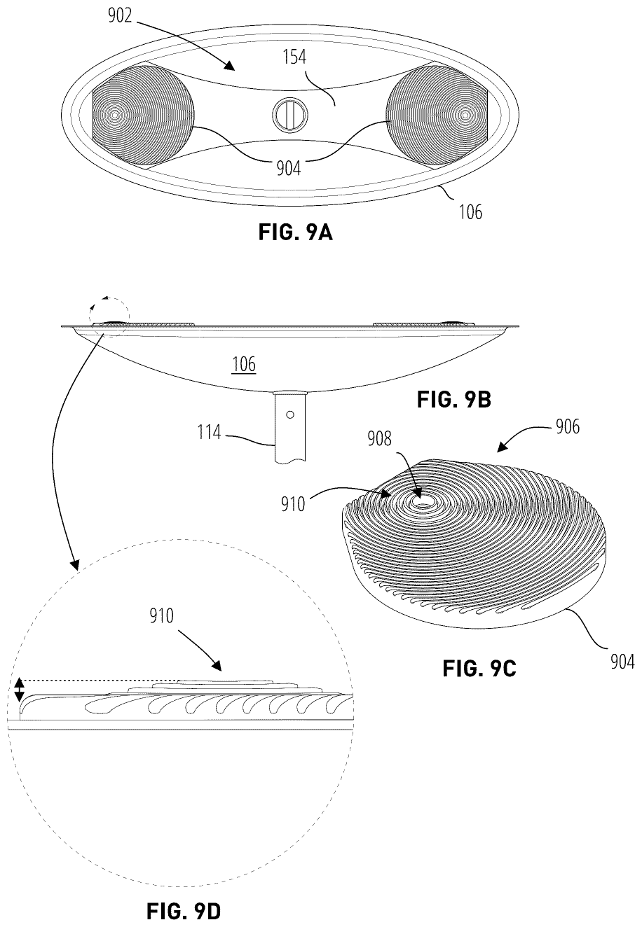

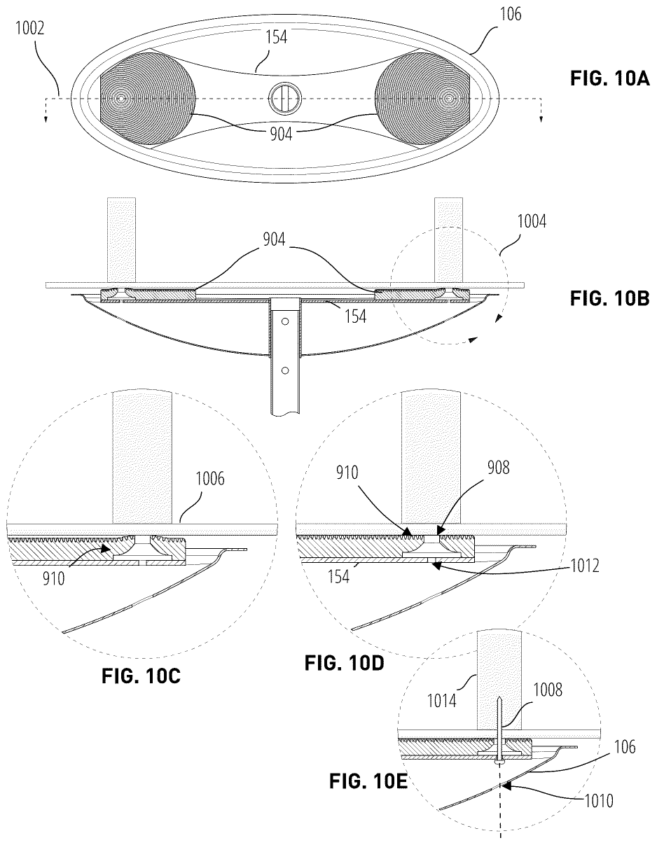

FIGS. 9A-9D, and FIGS. 10A-10E show various views of the ceiling plate 106, in accordance with one embodiment. The ceiling plate 106 comprises a rounded casing defining an internal empty space 902 that encloses an elongated horizontal support member 154 used for supporting two resilient pads 904 at two opposite ends thereof. The support member 154 is substantially “I” shaped, which provides an improved grip distribution. The support member 154 is coupled to a vertical tubular section 156 shaped and sized to be slidingly engageable into the top opening of the upper tubular member 114, and secured via a fastener 126 through co-aligned mounting holes 158 and 160.

Each resilient pad 904 is made of a resilient deformable elastomeric material and textured such as in the exemplary illustrated radial pattern of FIG. 9C comprising a series of grooves 906 encircling an aperture or hole 908. The texture is designed to provide an improved grip or frictional force while minimizing the contact area with the ceiling surface. Each pad 904 further comprises a raised portion 910 that sits higher than the outer edge of the pad, and configured to be reversibly compressed when the pad 904 is pushed against the ceiling. FIG. 10B is a cross-sectional view of the cut 1002 illustrated in FIG. 10A. FIGS. 10C-10E illustrate a section 1004 of FIG. 10B showing how each pad 904 are deformed during installation. The raised portion 910 of each pad 904 operates like a leaf spring and store elastic energy when compressed against the ceiling surface 1006. The compressed material of the pads 904 exerts in return an upwardly directed force against the same surface. This advantageously allows the user to easily adjust the amount of pressure being exerted via the Jackscrew mechanism. For example, the user can lightly extend the support pole to build some compression in the elastomeric pads 904 and prevent the pole from falling or tilting over by preventing rocking motion of the top portion of the pole from dislodging the traction force. However, this can be done without completely preventing the pole from being moved or displaced around the room. Therefore, the user can expand the pole via the threaded male member 116, but just enough to keep the pole upright. The pole can be moved or its position adjusted, and once the user has found the proper location for the pole, pressure can be increased to build up additional compression in the pads 904 until the pole is solidly secured (FIG. 10D).

In some embodiments, it may be necessary to affix the ceiling plate 106 via a supplementary fastener 1008 to the ceiling joist 1014. This may be desirable to prevent the pole from slipping should the expansion force be lost, for any reason. The supplementary fastener 1008 (e.g., screw shown in FIG. 10E or similar) may be engaged into the ceiling joist 1014 and the wood structure beyond via a series of co-aligned holes, namely a hole 1010 located at the bottom of the ceiling plate 106 itself which is co-aligned with the corresponding hole 1012 in the support member 154, and the hole 908 of the pad 908, as illustrated in FIG. 10E.

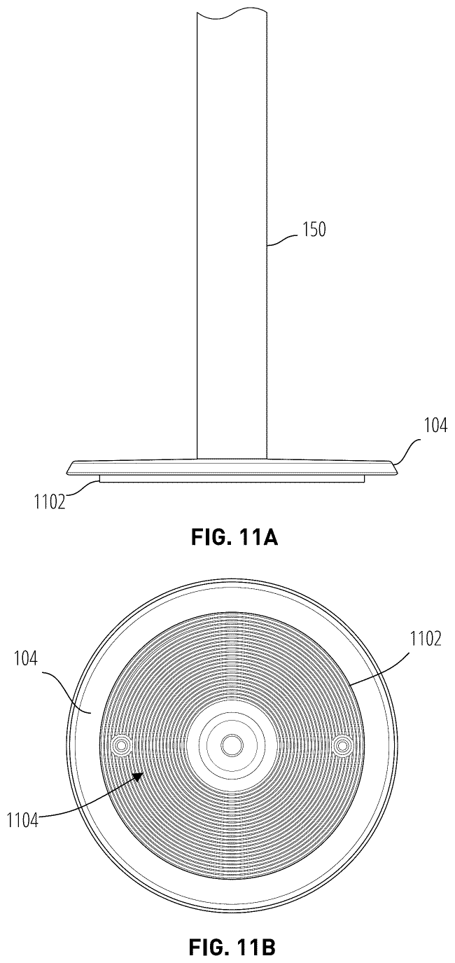

FIGS. 11A and 11B show the floor plate 104. In this embodiment, the floor plate 104 comprises a resilient floor pad 1102. The resilient floor pad 1102 is made of a compressible elastomeric material, and is manufactured to have a textured surface 1104. In this example, the surface of the pad comprises a series of raised concentric circles that provide friction while minimizing the contact area with the floor surface. Other types of patterns or textures may also be used.

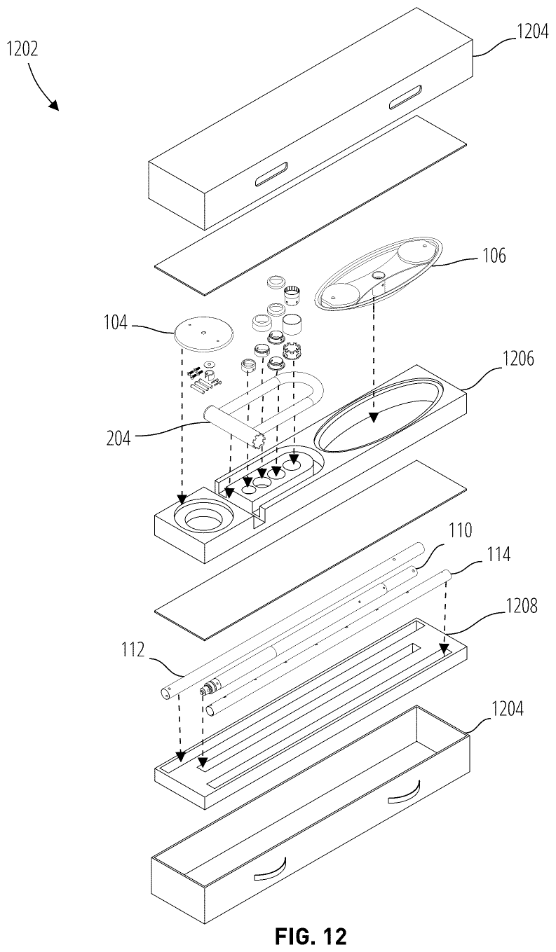

In some embodiments, components of the support pole are provided in a kit. FIG. 12 illustrates a disassembled perspective view of the embodiment of a packaged kit 1202 for the support pole 202. The support pole as described herein is designed to be advantageously packaged in a single box 1204 as shown, thereby minimizing the space required for storing and moving inventory. Foam or cardboard inserts or partitions 1206 and 1208 are provided comprising specifically shaped cells are provided to hold a number of items in place. In this example, a lower insert 1208 comprises parallel cells for the lower tubular member 110, middle tubular member 112 and upper tubular member 114, respectively. An upper inset 1206 is shown comprising cells for receiving the floor plate 104, ceiling plate 106, pivot bar 204, and four circular cells to receive various members required to assemble the support pole as illustrated.

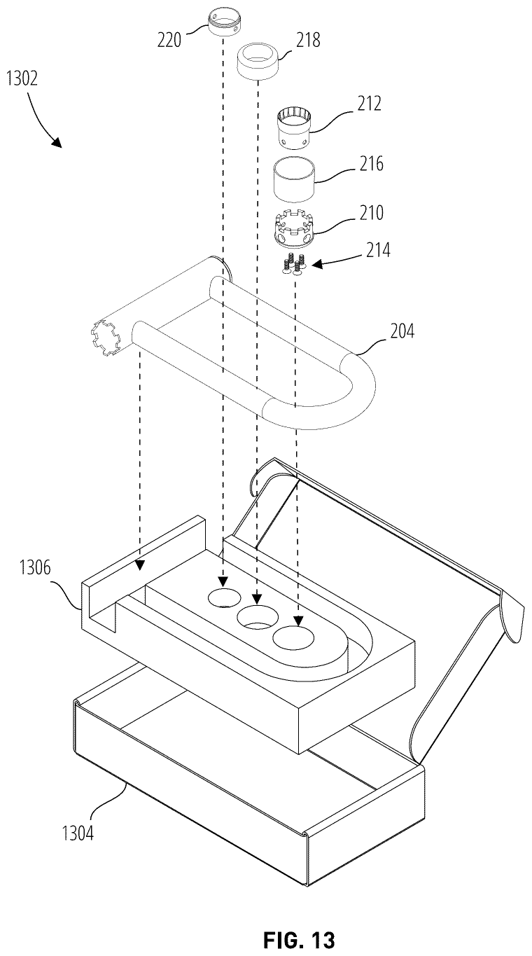

FIG. 13 shows a kit 1302 for a stand-alone pivot bar 204 accessory. A box 1304 is provided with a partition 1306 having therein cells to fittingly receive therein the various pieces. In this example, the partition 1206 comprises correspondingly-shaped cell to receive the pivot bar 204, and three circular cells located within the handle. One for the fasteners 214, the tapered collar member 212, the plastic sleeve 216 and the castellated collar 210, another for the top cover member 218 and the other for the mounting member 220.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A support pole comprising:
a floor plate;
a ceiling plate; and
an extensible pole comprising:
an upper tubular member coupled at an end thereof to the ceiling plate comprising a plurality of adjustment holes for adjusting the height of the support pole;
a middle tubular member, and
a lower tubular member comprising:
a plurality of mounting holes for removably affixing thereto an accessory; and
a male tensioning threaded member at a lower end thereof coupled to the floor plate.

2. The support pole of claim 1, wherein said plurality of mounting holes are covered by affixing to the lower tubular member a toroidal-shaped member.

3. The support pole of claim 1, further comprising:
a castellated collar slidingly engageable on said lower tubular section, and mounted via said mounting holes, the castellated collar comprising a plurality of upwardly extending teeth; and
wherein the accessory is a pivot bar accessory comprising:
a handle section; and
a tubular support element slidingly engageable on the lower tubular section over said castellated collar, the tubular support element coupled the handle section, and comprising at a lower end thereof a first plurality of downwardly extending teeth configured to fittingly engage in grooves defined between said upwardly extending teeth of the castellated collar, thereby preventing lateral motion of the pivot bar accessory.

4. The support pole of claim 3, wherein the handle section is C-shaped.

5. The support pole of claim 3, wherein each groove defines a distinct radial orientation of the handle section.

6. The support pole of claim 3, wherein downwardly extending teeth comprise substantially rounded corners.

7. The support pole of claim 3, further comprising a tubular sleeve member; and
wherein the castellated collar comprises a lip portion configured to support said sleeve member to cover said teeth.

8. The support pole of claim 1, wherein the accessory is a tray accessory.

9. The support pole of claim 1, wherein the ceiling plate comprises:
one or more resilient pads, each resilient pad comprising a textured surface.

10. The support pole of claim 9, wherein the textured surface comprises a plurality of grooves.

11. The support pole of claim 10, wherein each resilient pad further comprises a raised portion configured to store elastic energy upon being compressed against a ceiling surface.

12. A support pole kit comprising:
a floor plate;
a ceiling plate;
an upper tubular member comprising a plurality of adjustment holes for adjusting the height of the support pole;
a middle tubular member; and
a lower tubular member comprising:
a plurality of mounting holes for removably affixing thereto an accessory; and
a male tensioning threaded member at a lower end thereof coupled to the floor plate.

13. A method of assembling a support pole, the method comprising:
providing a floor plate on a floor;
coupling a lower tubular member comprising at a lower end thereof a tensioning member to the floor plate;
coupling a lower end of a middle tubular member to the upper end of the lower tubular member;
coupling an upper end of an upper tubular member to a ceiling plate;
slidingly adjusting an exposed length of the upper tubular member by slidingly moving the upper tubular member through the upper end of the middle tubular member;
coupling the upper tubular member to the upper end of the middle tubular member; and
tightening the tensioning member until enough tension is exerted by the floor plate and ceiling plate to secure the support pole.

14. The method of claim 13, wherein said coupling the lower tubular member with the lower end of the middle tubular member comprises:
affixing a castellated collar to a plurality of mounting holes on said lower tubular member;
slidingly engaging a sleeve member on the upper end of the lower tubular member until the sleeve member rests on a lip defined on the castellated collar; and
downwardly slidingly engaging a tubular support member of a pivot bar accessory onto said upper end of the upper tubular member until downwardly extending teeth of the pivot bar accessory engage grooves defined between upwardly oriented teeth of the castellated collar.

15. The method of claim 14, further comprising the steps of:
pulling upwards on the pivot bar accessory to disengage the downwardly extending teeth;
rotating the pivot bar around the lower tubular member to a designated radial orientation of a handle portion extending therefrom, the designated radial orientation allowing downward engagement of the downwardly extending teeth with said grooves; and
downwardly engaging the downwardly extending teeth with said grooves in said designated orientation, thereby preventing lateral motion of the handle portion.
